(19) United States
(12) Patent Application Publication
(10) Pub. No.: US 2007/0058775 A1
(43) Pub. Date: Mar. 15, 2007

(54) System for and method of authenticating marked objects

(76) Inventor: David Benderly, New York, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/225,323

(22) Filed: Sep. 13, 2005

(51) Int. Cl. G01N 23/223; G01T 1/36

(52) U.S. Cl. 378/45

(57) ABSTRACT

Non-destructive analysis of a residue of a coating applied to a marked object is performed to authenticate the object.

### BACKGROUND OF THE INVENTION

1. Field of the Invention

The present invention generally relates to authenticating marked objects, particularly gemstones, by non-destructive analysis of the composition of a residue remaining on the object after irradiation of a coating applied to the object with radiant energy.

2. Description of the Related Art

Laser etching or inscribing of a diamond surface with indicia of micron size to identify the diamond, especially if it is lost, stolen or mixed with other diamonds, as well as to identify the source or origin of the diamond, especially a jewelry retailer, is well known from U.S. Pat. No. 4,392,476; No. 4,467,172; No. 5,753,887; No. 5,932,119; No. 6,211,484; No. 5,149,938; No. 5,410,125; No. 5,573,684 and No. 6,483,073.

It is also well known from U.S. Pat. No. 6,747,242; No. 6,593,543 and No. 6,642,475 to mark the diamond by directing a radiant energy source at a coating applied on the diamond, thereby fusing the coating to the diamond in a pattern corresponding to the indicia to be marked on the diamond.

Despite such identification measures, a risk of forgery or fraudulent returns requires additional security precautions. For example, an image of the diamond being marked can be captured and digitally stored in a database or printed on a certificate of authenticity for subsequent verification that the diamond is authentic. Certain characteristics of the diamond, including color, size, measurements, grading and location of flaws can be observed by a jeweler and recorded, for example, on the certificate of authenticity.

As advantageous as these known security measures are, a jeweler's observations are subjective, and errors may occur in the recordal of the diamond's characteristics. The interpretation of an image is also subjective, but, in any event, a single image cannot uniquely describe a three-dimensional object, especially one with subsurface, embedded flaws. Raman scattering analysis has been proposed to provide unique information about the natural crystalline structure of the diamond, but much expertise is needed to use the vibrational equipment and to analyze the results.

### SUMMARY OF THE INVENTION

### Objects of the Invention

Accordingly, it is a general object of this invention to provide additional security for a marked object, especially a diamond.

More particularly, it is an object of the present invention to non-destructively authenticate a marked object.

Still another object of the present invention is to eliminate subjective actions in authenticating a marked object.

### FEATURES OF THE INVENTION

In keeping with the above objects and others which will become apparent hereinafter, one feature of the present invention resides, briefly stated, in a system for, and a method of, authenticating marked objects, such as microinscribed diamonds or like gemstones, including applying a coating to an object to be marked, and irradiating the coating with radiant energy to mark the object with indicia. For example, in one embodiment, relative movement between a source of the radiant energy and the coated object is controlled so as to mark the object in a pattern corresponding to the indicia. In another embodiment, the coating is pre-applied in the pattern corresponding to the indicia to a carrier; the carrier is applied to the object; and the coating is exposed to the radiant energy which causes the coating to fuse to the object in the pattern.

In both embodiments, the object is marked with indicia, such as a serial number, or a logo, or a coded symbol. The indicia is characterized by incisions or cuts etched in the object. Even after irradiation and cleaning of the object, a residue of the coating remains in the indicia.

One feature of this invention resides in analyzing the composition of the residue. If the residue composition is the same as the composition of the coating originally applied to the object, then the object is authentic. The coating composition is unique and, for example, can be one of a metal material, a metal oxide material, and a ceramic material, or can be an alloy or a mixture of different materials. The coating composition can be kept secret, or known only to authorized personnel, especially those involved in coating, irradiating and marking the object.

It is especially preferred if the analysis of the residue composition is done non-destructively, for example, by an x-ray fluorescence (XRF) analyzer operative for illuminating the residue with high energy photons, for measuring a spectrum of characteristic x-rays emitted by the residue after illumination by the photons, for storing a spectrum of the unique coating composition in a dedicated database, and for comparing the measured spectrum with the stored spectrum. Upon a successful comparison, the object is deemed authentic.

Thus, in accordance with this invention, a hidden security measure is employed to authenticate the object. The first line of security is typically the marking itself, especially if it's a number cross-referenced to a secure database. However, very often, the marking, in the case of a diamond, is a jeweler's logo which identifies the source of the diamond, but does not identify the diamond itself. In such cases, the use of the XRF analyzer detects the residue composition and confirms whether the unique coating associated with a particular jeweler was employed. Different jewelers may use different coatings. There are no subjective determinations involved. The residue composition either matches or does not match the coating composition. A diamond presented to a jeweler for return can be quickly assessed to authenticate that it did indeed originate with the jeweler.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a side elevational view of a marked and authenticated gemstone according to this invention;

FIG. 2 is a broken-away view of one embodiment for marking the gemstone of FIG. 1 according to this invention;

FIG. 3 is a sectional, enlarged view of a marked area of the gemstone being analyzed according to this invention; and

FIG. 4 is a broken-away view of another embodiment for marking the gemstone of FIG. 1 according to this invention.

### DETAILED DESCRIPTION OF THE PREFERRED EMBODIMENTS

Reference numeral 10 in FIG. 1 schematically depicts a diamond having a crown 12, a girdle 14, and a pavilion 16. The girdle 14 is a peripheral band between the crown and the pavilion and, in the preferred embodiment, an identifying indicium or mark 18 is formed on the girdle. The mark 18 can be a machine-readable indicium, such as a one- or two-dimensional bar code symbol, or can be a human-readable indicium, such as an alphabetical and/or numerical indicium, or can be a logo or image, for example, a certification mark of quality or of source of origin. The mark is permanent and is substantially imperceptible to the naked eye due to its micron dimensions, although clearly visible under magnification such as by a ten power loupe.

In accordance with this invention, the mark is formed as follows: In a first embodiment, as depicted in FIG. 4, a carrier, such as a generally planar stencil 20 having cutouts 22, is mounted on the girdle. One or both sides of the stencil may bear an adhesive layer to adhere the stencil in place on the girdle. The cutouts 22 have the same pattern as the mark 18.

The manufacture of the stencil is preferably performed not by the jeweler or ultimate user, but instead, by an authorized stencil supplier who has the facilities and equipment to make the stencil with the cutouts. Thus, a jeweler may pre-order a supply of apertured stencils, for example, with sequential numbers in a series, or with a logo, from the stencil supplier.

With the supply of apertured stencils on hand at the jeweler's premises, the jeweler selects a stencil and applies it along the girdle of a gemstone to be marked. Preferably, the stencil has an adhesive surface that adheres to the girdle.

Next, the cutouts of the stencil are filled with a fusible coating or layer 24, preferably of a high melting point material or mixture having a melting point exceeding that of the gemstone, e.g., diamond, to be marked. Preferably, the high melting point material is a metal such as tungsten, or a metal oxide material, or a ceramic material, or an alloy or mixture of such materials. The material layer may be sprayed, painted, dusted, or otherwise applied over the stencil to fill each cutout. The material layer 24 is preferably covered with a cover layer 26 that is preferably light-transmissive.

In a variant construction, the carrier has no apertures, and the material layer is directly applied in a desired marking pattern on the carrier, for example, by silk screening.

The jeweler then heats the material layer 24, typically by directing a source of radiant energy, such as a laser 28, at the cover layer 26. The laser 28 emits a laser beam 30 that is directed to the cover layer 26. The cover layer 26, if present, simply allows the emitted laser beam 30 to pass therethrough. The material layer 24 is heated and alters the girdle in dependence upon the energy level of the laser beam as adjusted by an energy controller 32.

In operation of the laser, there is concomitant sublimation of the material layer 24. The heat is so intense that a cavity 36 is formed in the girdle and the material layer 24 flows into, is fused to, and substantially lines or coats the interior surface of the cavity. The fused material layer 24 has a marking pattern which matches the shape of the cutouts which, of course, matches the shape of the identifying indicia or mark 18 desired.

The radiant energy source is preferably a laser, such as an excimer laser, but can by any type of laser or even a radio frequency or microwave source of radiation.

When tungsten is used for the material layer, the material layer 24 turns color after exposure to the radiation. The colored layer 24 presents a sharp contrast against the essentially colorless diamond. Other colors are obtainable when different metal oxide materials are used in the material layer.

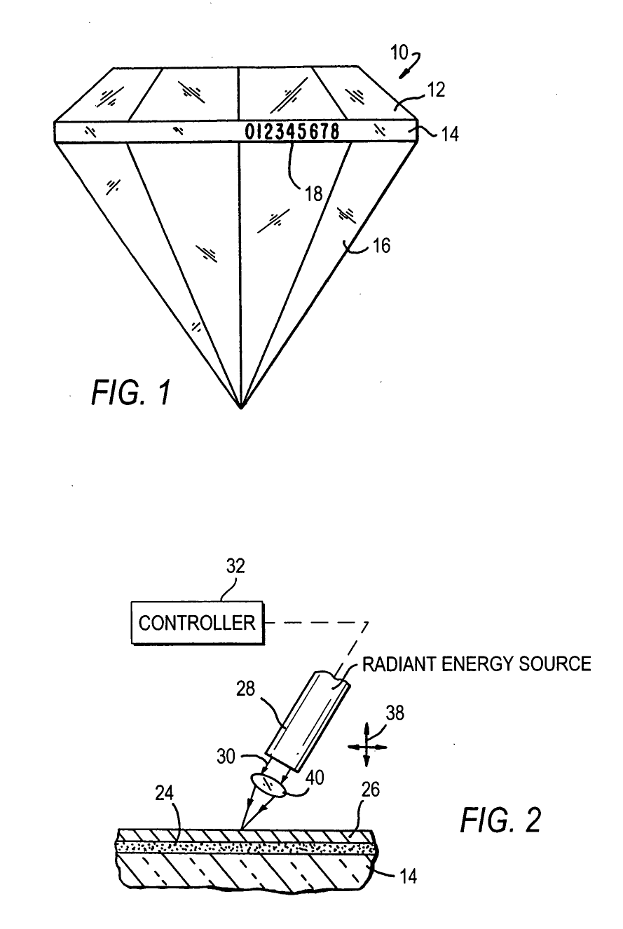

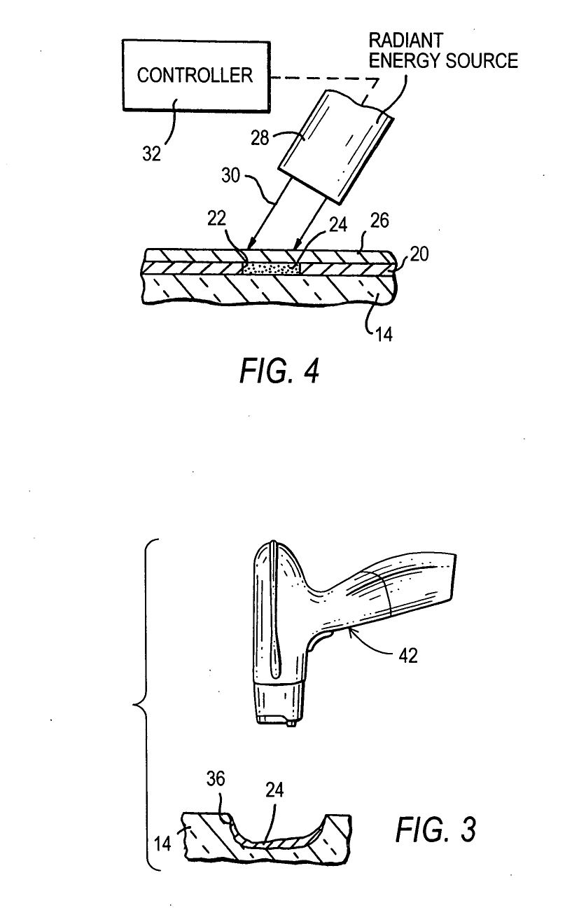

Rather than using a stencil, in a second and preferred embodiment, an entire exterior surface portion of the girdle can be applied or coated with the material layer 24, and be overcoated with the optional cover layer 26. Thereupon, as shown in FIG. 2, the laser beam 30 and/or the girdle 14 can be moved in the directions of the four-headed arrows 38 to directly trace the pattern of the indicia on the girdle surface portion. As before, the laser beam heats the material layer 24 at each spot where the laser beam impinges on the material layer, preferably after being focused by a focusing lens 40. The energy level of the laser beam forms the cavity 36, which is lined with the material layer 24, as shown in FIG. 3.

Once the gemstone is marked, a final heating step by baking the gemstone in an oven, or by exposing the gemstone to a finishing laser, may be needed.

The next step is to clean the gemstone, preferably in an acetone or acid wash. If a stencil or cover layer 26 was used, it is removed before cleaning. The resulting marked gemstone conforms to that shown in FIG. 1.

The marking can be performed on any outer surface of the gemstone, and not necessarily on the girdle. The gemstone need not necessarily be a diamond. Indeed, the marking can be performed on any object, not necessarily a gemstone.

As shown in FIG. 3, after irradiation by the radiant energy source 28, a small amount or residue of the material layer 24 is present in the cavity 36. In accordance with this invention, an analyzer 42, as depicted in FIG. 3, is employed to non-destructively determine the composition of the residue and, as described below, to determine whether the residue composition matches the composition of the material layer 24 prior to irradiation. A match indicates that the residue composition is the same as the material layer composition, thus authenticating the gemstone.

In the preferred embodiment, the analyzer 42 is an x-ray fluorescence (XRF) analyzer capable of simultaneously measuring the characteristic fluorescent x-rays of up to thirty or more elements in a sample, i.e., the residue composition. Essentially, each of the atomic elements present in a sample produces a unique set of characteristic x-rays that is a fingerprint for that specific element. XRF analyzers determine the chemistry of a sample by measuring the spectrum of the characteristic x-rays emitted by the different elements in the sample when it is illuminated by high energy photons (x-rays or gamma rays). A fluorescent x-ray is created when a photon of sufficient energy strikes an atom in the sample, dislodging an electron from one of the atom's inner orbital shells (lower quantum energy states). The atom regains stability, filling the vacancy left in the inner orbital shell with an electron from one of the atom's higher quantum energy orbital shells. The electron drops to the lower energy state by releasing a fluorescent x-ray, and the energy of this fluorescent x-ray (typically measured in electron volts, eV) is equal to the specific difference in energy between two quantum states of the dropping electron.

Because the quantum states of each electron orbital shell in each different type of atom (each of the atomic elements) is different, the energies of the fluorescent x-rays produced by different elements are also different. When a sample is measured via XRF, each element present in the sample emits its own unique fluorescent x-ray energy spectrum. By inducing and measuring a wide spectrum of the range of different characteristic fluorescent x-rays emitted by the different elements in the sample, the XRF analyzer can rapidly determine the elements present in the sample and their relative concentrations, in other words, the elemental chemistry of the sample. For samples with known ranges of chemical composition, such as common grades of metal alloys, the analyzer can also identify many sample types by name, typically in seconds. In typical samples containing many elements, the elements may range in concentrations from high percent levels down to parts per million (ppm).

In an initial calibration mode, the XRF analyzer user teaches a sample, i.e., the material layer, to the instrument with a one-minute measurement. The sample is named by the user, and the sample's x-ray spectrum is stored in a dedicated library in the analyzer that can hold hundreds of these spectra. When an unknown sample, i.e., the residue, is measured, the new spectrum is compared to the taught spectra stored in the library via least-squares fit analyses. If the new sample spectrum meets the specific sample-matching criteria (defined by the user) for one of the stored sample spectra, the new sample is matched and identified by the given name of that stored sample. This signature-match mode is similar conceptually to doing fingerprint analysis.

Thus, authentication is easily performed at a jeweler's premises. Operating the analyzer is well within the expertise of the jeweler and assists in identifying fraudulent returns.

It will be understood that each of the elements described above, or two or more together, also may find a useful application in other types of constructions differing from the types described above.

For example, as previously mentioned, the indicia to be marked may be a machine-readable code, in which case, an electro-optical reader can read the code. Preferably, the code contains the identity of the material layer composition, thereby informing the operator of the reader of the unique composition.

While the invention has been illustrated and described as embodied in a system for and method of authenticating marked objects, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

1-20. (canceled)

21: A method of authenticating marked diamonds supplied by jewelers, comprising the steps of:
a) applying a fusible coating to a diamond to be marked, the coating having a composition unique to each jeweler;
b) irradiating the coating with radiant energy to form in the diamond microscopic cavities that are arranged in a marking pattern that identifies the diamond, the cavities containing a residue of the coating after irradiation; and
c) identifying the jeweler that supplied the diamond by non-destructively analyzing a composition of the residue in the cavities, and comparing the composition of the residue with the composition unique to each jeweler to identify the jeweler upon a successful comparison.

22: The method of claim 21, wherein the analyzing step is performed by an x-ray fluorescence (XRF) analyzer for illuminating the residue with photons, for measuring a spectrum of characteristic x-rays emitted by the residue after illumination by the photons, for storing a spectrum of the unique composition in a dedicated database, and for comparing a measured spectrum with a stored spectrum.
